(19) United States
(12) Patent Application Publication
(10) Pub. No.: US 2016/0217117 A1
(43) Pub. Date: Jul. 28, 2016

(54) SMART ERASER

(71) Applicant: ABBYY Development LLC, Moscow (RU)

(72) Inventor: Anton Masalovitch, Moscow (RU)

(21) Appl. No.: 14/662,630

(22) Filed: Mar. 19, 2015

(30) Foreign Application Priority Data
Jan. 27, 2015 (RU) 2015102523

(51) Int. Cl. G06F 17/24

(52) U.S. Cl. CPC G06F 17/242; G06F 17/24

(57) ABSTRACT

Systems and methods for selectively erasing a portion of an electronic document are provided. An example method includes: receiving a user selected area of the electronic document that includes information to be erased, where the electronic document includes a background portion; determining whether the user selected area includes a corresponding text layer; and responsive to determining that the user selected area comprises the text layer, erasing a text portion corresponding to the text layer without modifying the background portion, where erasing the text portion includes coloring the text portion based on a color of the background portion that is adjacent to the text portion.

### CROSS REFERENCE TO RELATED APPLICATIONS

This application claims the benefit of priority to Russian Patent Application No. 2015102523, filed Jan. 27, 2015; disclosure of which is incorporated herein by reference in its entirety.

### TECHNICAL FIELD

The present disclosure is generally related to computer systems, and is more specifically related to systems and methods for processing electronic documents.

### BACKGROUND

An electronic document may be modified using document editing software. A user may use various tools associated with the document editing software to edit various aspects of the electronic document. For example, a user may wish to add or remove information from the electronic document.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a block diagram of one embodiment of a computing device operating in accordance with one or more aspects of the present disclosure;

FIG. 2A illustrates an example of using an eraser application to selectively erase information from an electronic document that includes a text portion, in accordance with one or more aspects of the present disclosure;

FIG. 2B illustrates an example of using an eraser application to selectively erase information from an electronic document that includes a text portion, in accordance with one or more aspects of the present disclosure;

FIG. 2C illustrates an example of using an eraser application to selectively erase information from an electronic document that includes a text portion, in accordance with one or more aspects of the present disclosure;

FIG. 2D illustrates an example of using an eraser application to selectively erase information from an electronic document that includes a text portion, in accordance with one or more aspects of the present disclosure;

FIG. 2E illustrates an example of using an eraser application to selectively erase information from an electronic document that includes a text portion, in accordance with one or more aspects of the present disclosure;

FIG. 3A illustrates an example of an electronic document that may be selectively erased, in accordance with one or more aspects of the present disclosure;

FIG. 3B illustrates an example of an electronic document that may be selectively erased, in accordance with one or more aspects of the present disclosure;

FIG. 4 depicts a flow diagram of an illustrative example of a method for selectively erasing information from an electronic document, in accordance with one or more aspects of the present disclosure; and

FIG. 5 depicts a more detailed diagram of an illustrative example of a computing device implementing the methods described herein.

### DETAILED DESCRIPTION

Described herein are methods and systems for selectively erasing information from an electronic document.

“Electronic document” herein shall refer to a file comprising one or more digital content items that may be visually rendered to provide a visual representation of the electronic document (e.g., on a display or a printed material). An electronic document may be produced by scanning or otherwise acquiring an image of a paper document and/or performing optical character recognition to produce the text layer associated with the document. In various illustrative examples, electronic documents may conform to certain file formats, such as PDF, DOC, ODT, PDF/A, DjVu, EPub, JPEG, JPEG 2000, JBIG2, BMP, etc. The electronic document may include any number of pixels.

“Computing device” herein shall refer to a data processing device having a general purpose processor, a memory, and at least one communication interface. Examples of computing devices that may employ the methods described herein include, without limitation, desktop computers, notebook computers, tablet computers, and smart phones.

“Coupled” herein shall refer to being electrically connected and/or communicatively coupled via one or more interface devices, adapters and the like.

“Text” herein shall refer to a single symbol or a string of symbols. Examples of text can include letters, characters, or numbers which may be in any language.

“Text layer” herein shall refer to a set of encoded text symbols. One commonly used encoding standard for text symbols is the Unicode standard. The Unicode standard commonly uses 8-bit bytes for encoding American Standard Code for Information Exchange (“ASCII”) characters and 16-bit words for encoding symbols and characters of many languages. Text layer may preliminary exist within the electronic document. Or text layer may be produced by performing an Optical Character Recognition (OCR).

“Text portion” herein shall refer to an area of the electronic document (in other words, set of pixels of the electronic document or image) belonging to text symbols represented within the image of a document.

“Information” herein shall refer to a collection of pixels within a target area. Pixels may be different in color from other its contiguous pixels within the target area. Information can include any object (e.g. text, pictures, etc). Information may include pixels that don't correspond to text portion. Information may contain only background portion or may include text portion.

“Deletion of information” herein shall refer to a change made to the color of pixels of information within the target area.

“Background pixel” herein shall refer to any pixel that does not represent text portion.

Conventionally, image editing software typically includes a tool called an “eraser” which is used to replace original pixels of an electronic document with background pixels filled with a specific color. A user may manually select a target area of the electronic document and apply the eraser thereto. Conventionally, the pixel-filling color may either be the same for all pixels to which the eraser will be applied. For example, if information such as text is located on a homogeneous background, the user may select the text area and the eraser fills all pixels within the selected area (including pixels that are not part of the text) with the background color. The result is a homogeneous image and a deletion of the text.

When the text to be deleted is located on a non-homogeneous background, all pixels in the target area conventionally would be filled in a similar manner as with a homogeneous background—either with a predetermined color or alternatively with a color computed by averaging the colors of pixels contiguous to the target area. As a result, the coloring in the selected area may not match the non-homogeneous background, and the attempt to erase the text in the selected area may be conspicuous. Some conventional approaches have attempted to address this problem by allowing a user to isolate each symbol into a separate area and applying an eraser to each such area individually (either with a predetermined color or a color average). However, these approaches may require considerable user involvement in the information deletion process, may be time-consuming and may be based on an assumption that the software in use includes an eraser tool that would support the selection of random-shaped areas.

Aspects of the present disclosure address these and other shortcomings by providing a smart eraser system that may remove information of an electronic document in a manner that may be substantially inconspicuous (inconspicuous or almost inconspicuous) to a viewer of the electronic document. In some implementations, the smart eraser system receives, via a graphical user interface (GUI), a user selected area to be erased from a document including a background portion. The smart eraser system also determines whether the user selected area to be erased includes a text portion. Text portion within the image may have corresponding text layer. In other words, the smart eraser system determines whether the area, selected by the user to be erased, includes a text layer. Text layer may have existed originally or may have been produced by the OCR. If the user selected area does not contain text portion, OCR is unable to produce a text layer. If the user selected area contains the text, the smart eraser system changes the color of the pixels belonging to the text, rather than all pixels within the selected area. When erasing the text portion in the selected area, the smart eraser system colors the text portion based on a color of the background portion that is adjacent to the text portion. The color of the text pixel may be replaced by one averaged from that of the contiguous background pixels. Contrary to the conventional mechanisms where all pixels in the selected area are filled with same color, aspects of the present disclosure may apply different colors to pixels within the selected area, thereby making deletion substantially unnoticeable to a viewer. In addition, by not changing the color of background pixels within the selected area, the smart eraser system may further make deletion of information substantially inconspicuous.

Various aspects of the above referenced methods and systems are described in details herein below by way of examples, rather than by way of limitation.

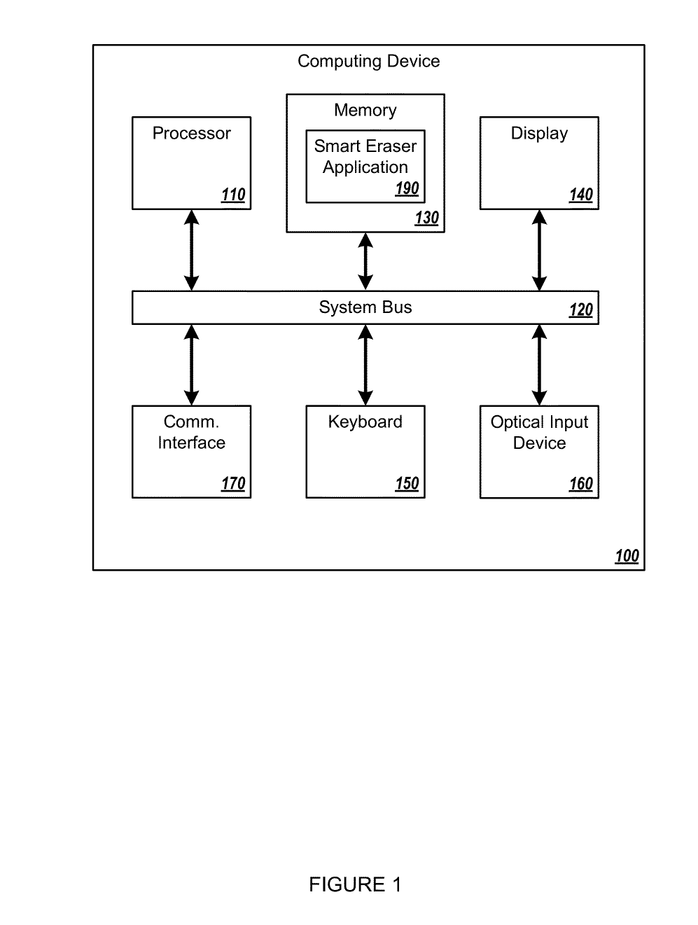

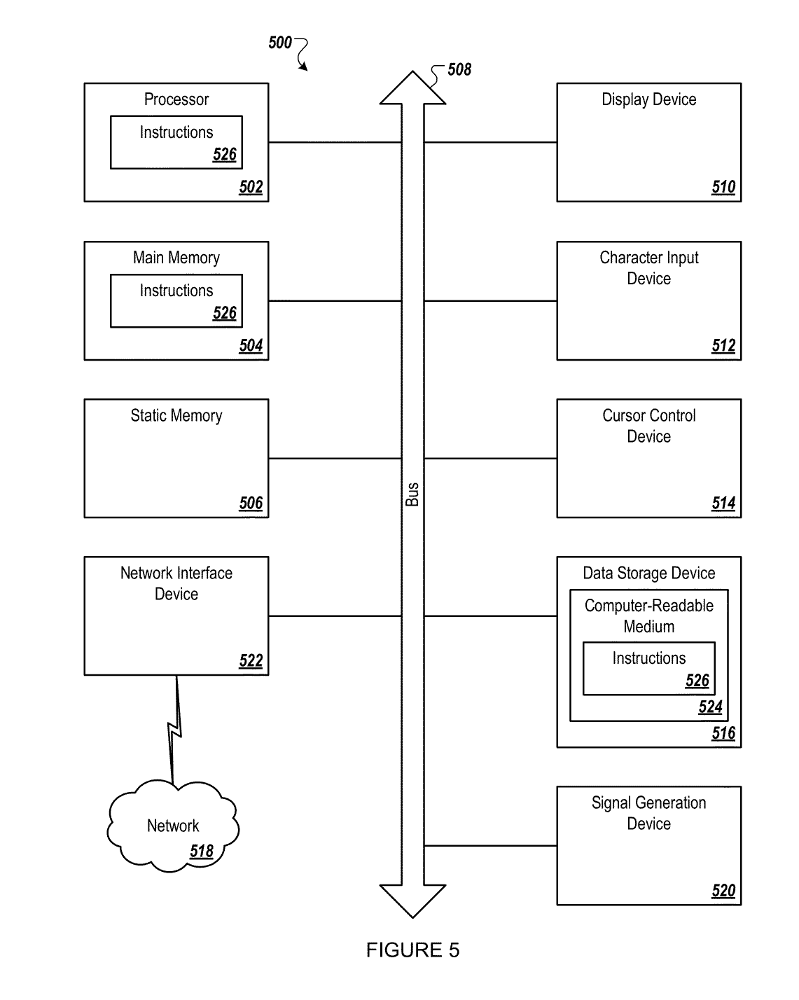

FIG. 1 depicts a block diagram of one illustrative example of a computing device 100 operating in accordance with one or more aspects of the present disclosure. In illustrative examples, computing device 100 may be provided by various computing devices including a tablet computer, a smart phone, a notebook computer, or a desktop computer. An example of a computing device implementing aspects of the present disclosure is discussed in more detail below with reference to FIG. 5.

Computing device 100 may include a processor 110 coupled to a system bus 120. Other devices coupled to system bus 120 may include a memory 130, a display 140, a keyboard 150, an optical input device 160, a touch screen (not shown), and one or more communication interfaces 170.

In various illustrative examples, processor 110 may be provided by one or more processing devices, such as general purpose and/or specialized processors. Memory 130 may comprise one or more volatile memory devices (for example, RAM chips), one or more non-volatile memory devices (for example, ROM or EEPROM chips), and/or one or more storage memory devices (for example, optical or magnetic disks).

Optical input device 160 may be provided by a scanner or a still image camera configured to acquire the light reflected by the objects situated within its field of view. In some embodiments, the optical input device 160 is external to the computing device 100 and may be electronically coupled to the computing device 100 via a wired or wireless connection.

Memory 130 may store instructions of a smart eraser application 190 for erasing portions of an electronic document. In certain implementations, smart eraser application 190 may perform methods of identifying transformations to be applied to at least part of the electronic document in order to remove information from the electronic document in a manner that may be difficult to notice by a viewer, in accordance with one or more aspects of the present disclosure. The smart eraser application 190 may identify a target area and determine a color to use to color pixels within the target area based on neighboring pixels, as described herein. The smart eraser application 190 may be implemented as a function or tool to be invoked via a user interface of another application. Alternatively, the smart eraser application 190 may be implemented as a standalone application.

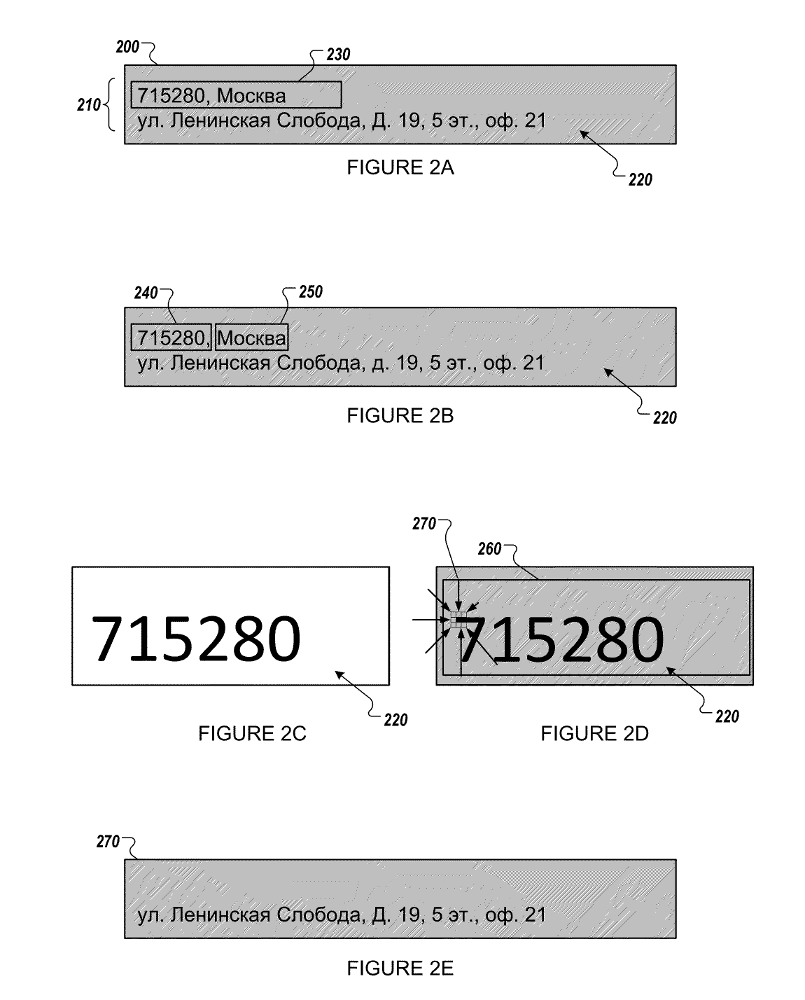

In an illustrative example, computing device 100 may acquire an electronic document (e.g., a document image). A user may open or create the electronic document using the smart eraser application 190. The computing device 100 may receive a user selected area of the electronic document. The user selected area may be any shape (e.g., rectangle, circle, polygon, etc.). The computing device 100 may determine whether the user selected area includes a text portion. As was mentioned, the text portion within the image may have a corresponding text layer. In other words, the smart eraser system determines whether the user selected area to be erased includes the text layer. Text layer may have existed originally or may have been produced by the OCR. If the user selected area does not contain a text portion, OCR is unable to produce a text layer. If the user selected area includes a text layer, the computing device 100 may color the text portion based on a color of one or more background pixels of the electronic document that are adjacent to the text portion. Further details and operations of the eraser application 190 are described in conjunction with FIGS. 2-4.

FIGS. 2A-E illustrate an example of using an eraser application to selectively erase information from an electronic document 200 that includes a text portion 210 and a background portion 220, in accordance with one or more aspects of the present disclosure. As illustrated, the background portion 220 is homogenously colored. Any type of color, or arrangement of colors may comprise the background portion and the background portion 220 may be non-homogenously or heterogeneously colored. For example, the background portion 220 may be a photograph or image with many different colors. The illustrated elements of the electronic document 200 layout have been selected for illustrative purposes only and are not intended to limit the scope of this disclosure in any way. FIG. 2A illustrates a selected area 230 of some of the text in the text portion 210. As described herein, the selected area 230 can be specified by a user via a GUI. The eraser application performs a character recognition operation (e.g., OCR) to determine whether the selected area 230 of the electronic document 200 include a text portion. E.g. if there is a text portion, OCR may produce a text layer. In some instances the text layer already exists. If the selected area does not contain a text portion, OCR is unable to produce the text layer. In other words, the smart eraser system determines whether the user selected area to be erased includes the text layer. As illustrated, the selected area 230 includes a text portion (“115280, [symbol] ”) and a background portion 220. Text portion has a corresponding text layer, e.g. encoded text symbols. Corresponding text layer may be included in the electronic document or may be produced by the character recognition operation. Once text layer is detected/produced within the selected area 230, the eraser application may define one or more sub-areas of text, as shown in FIG. 2B. As illustrated, the eraser application defines sub-area 240 (115280) and sub-area 250 ( [symbol] ). In some embodiments, the eraser application defines sub-areas based on a delimiting factor, such as a space between symbols, a symbol (e.g., comma, semi-colon), etc. In some embodiments, the sub-areas are defined to cover pixels that include text characters within the text portion and to preclude any pixels that include text characters from being located on sub-area boundaries. Sub-areas may also include some pixels from background portion. In some embodiments, each pixel within the subarea that is closest to the subarea boundary and that includes at least a portion of a text character should be distanced from the subarea boundary by at least one background pixel.

In some embodiments, the eraser application then converts each sub-area into a binary representation of the sub-area. A binary representation of an image has only two possible values for each pixel. Typically the two colors used for a binary representation are black and white though any two colors can be used. When binarizing text and background pixels, the text pixels can be colored black and the background pixels can be colored white. The eraser application can use the binary representation of the sub-area to distinguish text pixels from background pixels. When the eraser application distinguishes the text portion from the background portion, the eraser application can more accurately select the text portion and delete only the text portion from the electronic document. For example, the eraser application can select all the black pixels in the binary representation of the sub-area to select the text portion. With only the area occupied by the text portion selected, the eraser application can color only that area, as described herein.

FIG. 2C illustrates a binary representation of sub-area 240. The binary representation of the sub-area can be created by any known method. There are two main groups of binarization methods: global thresholding and adaptive thresholding. Global thresholding methods (e.g. Otsu's method) use an optimum threshold for all pixels in a document to distinguish pixels. Adaptive theresholding methods (e.g. Sauvola method) compute the threshold for each pixel by using information from contiguous pixels. In some embodiments, when creating the binary representation of the sub-area, the eraser application converts the color of the pixels containing text in the sub-area to black and converts all other pixels in the background 220 of the sub-area to white.

FIG. 2D illustrates how the eraser application may use one or more background pixels 260 to color text portion in the sub-area 240 without coloring the background portion 220. The eraser application may determine an average of each background pixel 260 that is adjacent to the text pixel to be erased, as described herein. For example, the eraser application may select a first text pixel in the sub-area 240. The eraser application then identifies background pixels 260 that are adjacent to the first text pixel and determines a color of each of the background pixels 260. The eraser application determines an average color using the color of each of the background pixels 260. Then, the eraser application colors the first text pixel using the color average. The eraser application may then identify a second text pixel and color it using the same approach used to color the first text pixel. The eraser application may continue this series of operations until all of the text pixels from text portion with the sub-area 240 have been colored. In this manner, information within the selected area 230 is deleted from the electronic document 200. In some embodiments, image inpainting algorithms may be used to color text in the sub-area. In the digital world, inpainting (also known as image interpolation or video interpolation) refers to the application of sophisticated algorithms to replace lost or corrupted parts of the image data (mainly small regions or to remove small defects).

FIG. 2E illustrates the result of selectively erasing the text portion within the selected area 230 of the electronic document 200. As illustrated, the information “115280, [symbol] ” has been deleted from the electronic document 200.

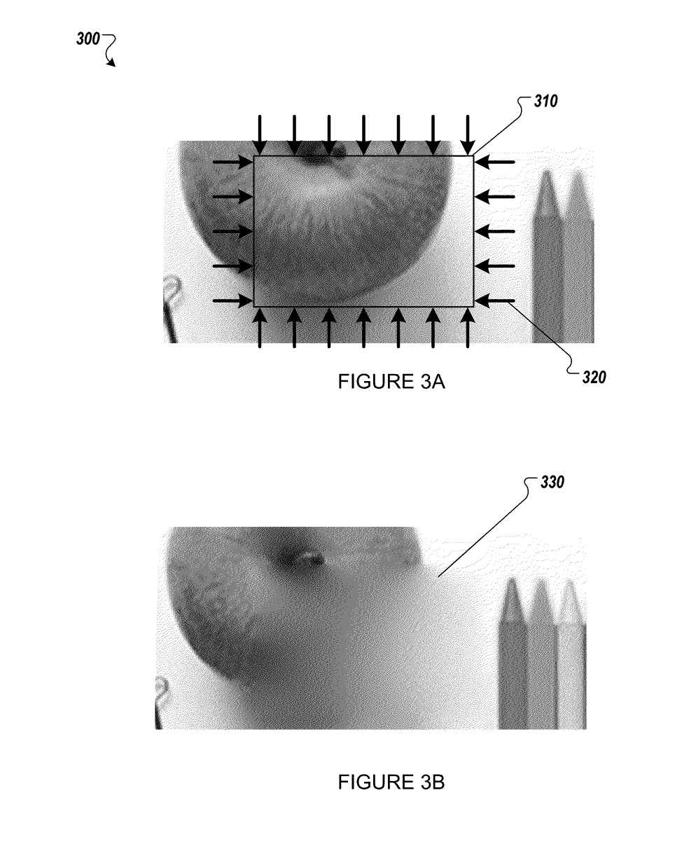

FIGS. 3A-B illustrate an example of an electronic document 300 that may be selectively erased by the eraser application 190 of FIG. 1, in accordance with one or more aspects of the present disclosure. As illustrated in FIG. 3A, the electronic document 300 is an image that does not include a text portion. Using a selection tool within a graphical user interface (GUI), a user can select an area 310 of the electronic document 300 to be erased. The eraser application then performs a character recognition operation (e.g., optical character recognition (OCR)) to determine whether the selected area 310 of the electronic document 300 includes a text layer. Since, as illustrated, the selected area 310 does not include a text, the character recognition operation does not produce any text layer. The eraser application then colors the pixels in the selected area 310 with color derived from pixels 320 that are adjacent to the selected area 310. In some embodiments, each pixel in the selected area 310 is filled with a color that derived by taking a color-average from those pixels that are adjacent to the pixel in the selected area 310. For example, the eraser application may select a first pixel in the selected area 310. The eraser application then identifies adjacent pixels that border the first pixel. The eraser application identifies a color for each of the adjacent pixels and then determines an average color using the color of each of the adjacent pixels. The eraser application then colors the first pixel using the average color. The eraser application may select a second pixel next to the first pixel in the selected area 310. The eraser application then identifies adjacent pixels that border the second pixel including the first pixel. The eraser application identifies a color for each of the adjacent pixels and then determines an average color using the color of each of the adjacent pixels, including the first pixel. The eraser application then colors the second pixel using the average color. As a result, the varying colors of the pixels in the selected area allow the selected area to better blend with the pixels surrounding the selected area, thereby making the erased area less noticeable to a viewer. FIG. 3B illustrates an area 330 that represents the result of filling each pixel in the user selected area 310 of FIG. 3A with a color that is determined as a result of the color-average operation using the contiguous pixels.

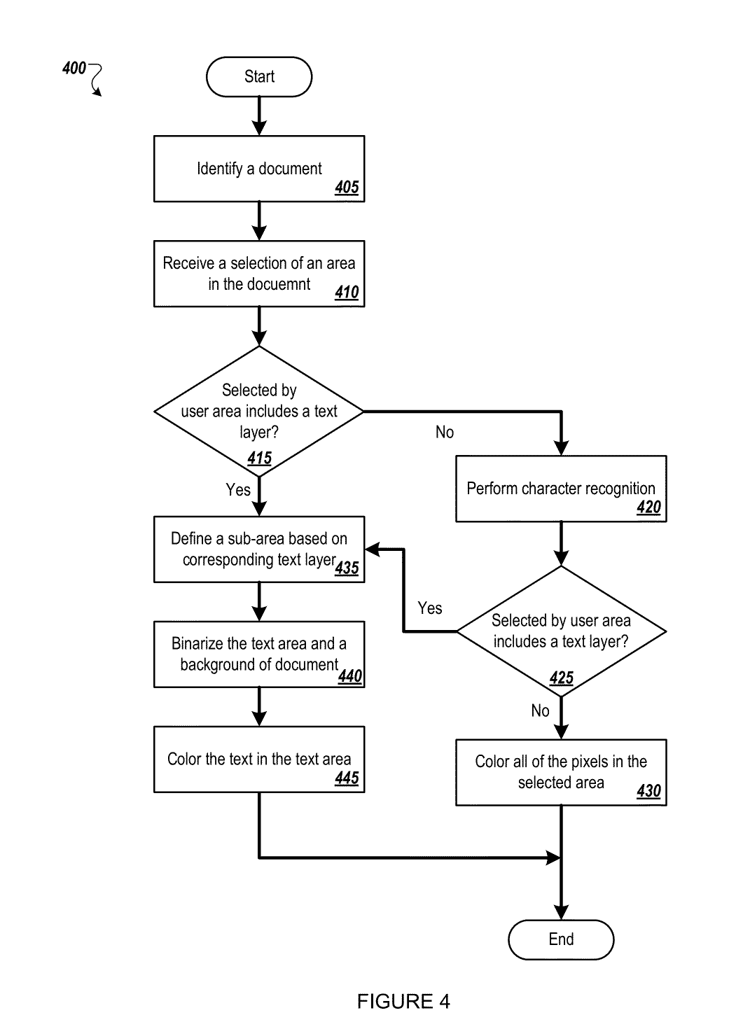

FIG. 4 depicts a flow diagram of an illustrative example of a method 400 for selectively erasing a portion of an electronic document, in accordance with one or more aspects of the present disclosure. Method 400 and/or each of its individual functions, routines, subroutines, or operations may be performed by one or more processors of the computer system (e.g., computing device 100 of FIG. 1) executing the method. The method 400 may also be performed by processing logic that comprises hardware (e.g., circuitry, dedicated logic, programmable logic, microcode, etc.), software (e.g., instructions run on a processing device to perform hardware simulation), or a combination thereof. For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In certain implementations, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processing threads implementing method 400 may be executed asynchronously with respect to each other.

Referring to FIG. 4, method 400 begins at block 405 where the processing logic identifies an electronic document. The processing logic may identify a document created or opened by a user using an eraser application (such as eraser application 190 of FIG. 1). The document may be an image that includes a background portion.

At block 410, the processing logic receives a user selected area of the electronic document that includes information that is to be erased. In some embodiments, the processing logic receives the user selected area via a GUI that is provided in conjunction with the eraser application.

At block 415, the processing logic determines whether the selected area of the document to be erased includes a text layer. In some embodiments, determining whether the selected area of the document to be erased includes a text layer includes determining whether the selected area of the document includes a preexisting text layer. Some electronic document formats can store information (e.g., images, graphics, text) in different layers. A text layer may include encoded text symbols and data about positions of text symbols within the image. In some embodiments, the text is vector-based text that is represented using vector-based graphics. Vector-based graphics refers to the use of geometrical primitives such as points, lines, curves, and shapes or polygons—all of which are based on mathematical expressions—to represent symbols in computer graphics. In some embodiments, the processing logic can inspect the electronic document for a text layer, such as by analyzing metadata that includes layer data associated with the electronic document or by inspecting the electronic document itself for different layers. The processing logic can use the text layer to ascertain the boundaries of the text such that those pixels within the boundaries are colored, as described herein.

When the processing logic determines that the selected area of the document to be erased does not include a a preexisting text layer, the processing logic performs character recognition operation (e.g., OCR) at block 420 to identify positioning of text symbols and creating a text layer including the positioning information and geometry of the text. In some embodiments, performing the character recognition operation includes analyzing the selected area to detect one or more characters, and then creating a text layer using the detected characters. The processing logic can also store the text layer in a data storage.

At block 425, the processing logic determines, based on the OCR results, whether the selected area of the document to be erased includes a corresponding text layer. For example, the processing logic determines that a new text layer was created during the execution of block 420. When the selected area of the document to be erased does not include a text layer, at block 430 the processing logic colors all of the pixels in the selected area with a color averaged from that of contiguous background pixels, as further described in conjunction with FIGS. 3A-B.

When the selected area of the document to be erased includes a text layer, at block 435 the processing logic may define a sub-area based on the text layer, as further described in conjunction with FIG. 2B.

At block 440, the processing logic binarizes the area of the document within the user selection by any known binarization method (global thresholding or adaptive thresholding), as further described in conjunction with FIG. 2C. In some embodiments, the processing logic binarizes the entire electronic document. In some embodiments, the processing logic binarizes each of the pixels within the selected area. Alternatively, the processing logic binarizes each of the pixels in the sub-area of the selected area. The processing logic can use a text layer (e.g., vector-based text) to identify the boundaries of the text portion of the electronic document and then binarize the area of the document within the user selection based on the boundaries of the text portion to prepare the text pixels for coloring.

At block 445, the processing logic colors the text in the text area of the user selected area without coloring the background portion, as was described above in conjunction with FIG. 2D. For example, the processing logic can select all black pixels resulting from binarization that represent text pixels. In some embodiments, the processing logic colors each text pixel using colors of the adjacent background pixels that were contained in the image prior to the binarization. The processing logic uses colors of the adjacent background pixels so that the result of deletion of information (e.g., text) from the selected area is substantially inconspicuous. In some embodiments, coloring the text portion without coloring the background portion, wherein the text portion is colored based on a color of the background portion that is adjacent to the text portion includes identifying a text pixel in the text portion, identifying a set of background pixels outside the text portion that is adjacent to the text pixel in the text portion. The set of background pixels may be any number of pixels. For example, the processing logic may identify a single pixel, as illustrated in FIG. 2D. The set of background pixels outside the single pixel may include each background pixel that borders (e.g., horizontally, vertically, diagonally) the single pixel, as indicated by the arrows 270 of FIG. 2D. The processing logic may then identify a color of the set of background pixels, which may include identifying a color for each of pixel in the set of background pixels. When the set of background pixels includes two or more pixels, the processing logic may blend the colors for each of the at least two pixels in the set of background pixels. For example, when a first background pixel is yellow and a second background pixel is red, the blended color is orange. The processing logic may then color the text pixel based on the color of the identified set of background pixels. As in the above example, the processing logic would color the text pixel in orange.

Upon completion of blocks 430 or 445, the removal of information from the user-selected area is achieved.

FIG. 5 illustrates a more detailed diagram of an example computing device 500 within which a set of instructions, for causing the computing device to perform any one or more of the methods discussed herein, may be executed. The computing device 500 may include the same components as computing device 100 of FIG. 1, as well as some additional or different components, some of which may be optional and not necessary to provide aspects of the present disclosure. The computing device may be connected to other computing device in a LAN, an intranet, an extranet, or the Internet. The computing device may operate in the capacity of a server or a client computing device in client-server network environment, or as a peer computing device in a peer-to-peer (or distributed) network environment. The computing device may be a provided by a personal computer (PC), a tablet PC, a set-top box (STB), a Personal Digital Assistant (PDA), a cellular telephone, or any computing device capable of executing a set of instructions (sequential or otherwise) that specify operations to be performed by that computing device. Further, while only a single computing device is illustrated, the term “computing device” shall also be taken to include any collection of computing devices that individually or jointly execute a set (or multiple sets) of instructions to perform any one or more of the methodologies discussed herein.

Exemplary computing device 500 includes a processor 502, a main memory 504 (e.g., read-only memory (ROM) or dynamic random access memory (DRAM)), and a data storage device 516, which communicate with each other via a bus 508.

Processor 502 may be represented by one or more general-purpose processing devices such as a microprocessor, central processing unit, or the like. More particularly, processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute instructions 526 for performing the operations and functions discussed herein.

Computing device 500 may further include a network interface device 522, a display device 510, an character input device 512 (e.g., a keyboard), a touch screen input device and a cursor control device 514.

Data storage device 516 may include a computer-readable storage medium 524 on which is stored one or more sets of instructions 526 embodying any one or more of the methodologies or functions described herein. Instructions 526 may also reside, completely or at least partially, within main memory 504 and/or within processor 502 during execution thereof by computing device 500, main memory 504 and processor 502 also constituting computer-readable storage media. Instructions 526 may further be transmitted or received over network 518 via network interface device 522.

In certain implementations, instructions 526 may include instructions of method 400 for selectively erasing portions of an electronic document, and may be performed by application 190 of FIG. 1. While computer-readable storage medium 524 is shown in the example of FIG. 5to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “computing”, “calculating”, “obtaining”, “identifying,” “modifying” or the like, refer to the actions and processes of a computing device, or similar electronic computing device, that manipulates and transforms data represented as physical (e.g., electronic) quantities within the computing device's registers and memories into other data similarly represented as physical quantities within the computing device memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Various other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
receiving, via a graphical user interface (GUI), a user selected area of a document comprising information to be erased, the document comprising a background portion;
determining whether the user selected area comprises a corresponding text layer; and
responsive to determining that the user selected area comprises the text layer, erasing a text portion corresponding to the text layer without modifying the background portion, wherein erasing the text portion comprises coloring the text portion based on a color of the background portion that is adjacent to the text portion.

2. The method of claim 1 further comprising binarizing the area of the document within the user selected area, and wherein the text portion is colored based on colors of the background portion that is adjacent to the text portion prior to the binarizing.

3. The method of claim 2 further comprising defining a sub-area of the user selected area that comprises the text portion, wherein binarizing the area of the document comprises binarizing pixels within the sub-area.

4. The method of claim 1, wherein the background portion is a non-homogeneous image that comprises a plurality of colors.

5. The method of claim 1, wherein erasing the text portion comprises:
identifying a text pixel in the text portion;
identifying a set of background pixels outside the text portion that is adjacent to the text pixel in the text portion;
identifying a color of the set of background pixels; and
coloring the text pixel based on the color of the identified set of background pixels.

6. The method of claim 5, wherein the set of background pixels comprises at least two pixels, wherein identifying the color of the set of background pixels comprises:
identifying a color for each of the at least two pixels in the set of background pixels; and
blending the colors for each of the at least two pixels in the set of background pixels.

7. The method of claim 6, wherein the at least two pixels in the set of background pixels are contiguous.

8. The method of claim 1, further comprising obtaining the text layer by performing OCR.

9. The method of claim 1, wherein the text layer preexists in the document.

10. A system comprising:
a memory; and
a processor operatively coupled to the memory, the processor to:
receive, via a graphical user interface (GUI), a user selected area of a document comprising information to be erased, the document comprising a background portion;
determine whether the user selected area comprises a corresponding text layer; and
responsive to determining that the user selected area comprises the text layer, erasing a text portion corresponding to the text layer without modifying the background portion, wherein erasing the text portion comprises coloring the text portion based on a color of the background portion that is adjacent to the text portion.

11. The system of claim 10, wherein the processor is further to binarize the area of the document within the user selected area, and wherein the text portion is colored based on colors of the background portion that is adjacent to the text portion prior to the binarizing.

12. The system of claim 10, wherein the background portion is a non-homogeneous image that comprises a plurality of colors.

13. The system of claim 10, wherein when erasing the text portion based on a color of the background portion that is adjacent to the text portion, the processor is to:
identify a text pixel in the text portion;
identify a set of background pixels outside the text portion that is adjacent to the text pixel in the text portion;
identify a color of the set of background pixels; and
color the text pixel based on the color of the identified set of background pixels.

14. The system of claim 13, wherein the set of background pixels comprises at least two pixels, wherein when identifying the color of the set of background pixels, the processor is to:
identify a color for each of the at least two pixels in the set of background pixels; and
blend the colors for each of the at least two pixels in the set of background pixels.

15. A non-transitory computer readable storage medium comprising instructions that, when executed by a processor, cause the processor to perform operations comprising:
receiving, via a graphical user interface (GUI), a user selected area of a document comprising information to be erased, the document comprising a background portion;
determining whether the user selected area comprises a corresponding text layer; and
responsive to determining that the user selected area comprises the text layer, erasing a text portion corresponding to the text layer without modifying the background portion, wherein erasing the text portion comprises coloring the text portion based on a color of the background portion that is adjacent to the text portion.

16. The non-transitory computer readable storage medium of claim 15, the operations further comprising selecting the text portion within the user selected area of the document in response to determining that the user selected area of the document to be erased comprises the text layer.

17. The non-transitory computer readable storage medium of claim 15 the operations further comprising binarizing the area of the document within the user selected area, and wherein the text portion is colored based on colors of the background portion that is adjacent to the text portion prior to the binarizing.

18. The non-transitory computer readable storage medium of claim 15, wherein erasing the text portion based on a color of the background portion that is adjacent to the text portion comprises:
identifying a text pixel in the text portion;
identifying a set of background pixels outside the text portion that is adjacent to the text pixel in the text portion;
identifying a color of the set of background pixels; and
coloring the text pixel based on the color of the identified set of background pixels.

19. The non-transitory computer readable storage medium of claim 18, wherein the set of background pixels comprises at least two pixels, wherein identifying the color of the set of background pixels comprises:
identifying a color for each of the at least two pixels in the set of background pixels; and
blending the colors for each of the at least two pixels in the set of background pixels.

20. The non-transitory computer readable storage medium of claim 19, wherein the at least two pixels in the set of background pixels are contiguous.

21. The non-transitory computer readable storage medium of claim 15, further comprising obtaining the text layer by performing OCR.

22. The non-transitory computer readable storage medium of claim 15, wherein the text layer preexists in the document.
